(19) United States
(12) Patent Application Publication
(10) Pub. No.: US 2025/0048066 A1
(43) Pub. Date: Feb. 6, 2025

(54) Control of a Safety Function of a Motor Vehicle

(71) Applicant: Bayerische Motoren Werke Aktiengesellschaft, Muenchen (DE)

(72) Inventors: Kai HOESL, Iffeldorf (DE); Helmut WAGATHA, Oberschleissheim (DE)

(21) Appl. No.: 18/742,808

(22) Filed: Jun. 13, 2024

(30) Foreign Application Priority Data
Aug. 3, 2023 (DE) 10 2023 120 584.6

(51) Int. Cl. H04W 4/44; B60R 25/00; B60R 25/01; H04L 67/12; H04W 4/80

(52) U.S. Cl. CPC H04W 4/44; B60R 25/002; B60R 25/01; H04L 67/12; H04W 4/80; B60R 2325/205

(57) ABSTRACT

A method for controlling a safety function of a motor vehicle. A wireless connection is initiated between a hand-held unit and the motor vehicle. An expected volume of data that is supposed to be transmitted via the interface is determined. An interval of time is determined from the strength of the expected volume of data. The connection is regularly activated at the interval of time.

### CROSS REFERENCE TO RELATED APPLICATION

This application claims priority under 35 U.S.C. § 119 from German Patent Application No. DE 10 2023 120 584.6, filed Aug. 3, 2023, the entire disclosure of which is herein expressly incorporated by reference.

### BACKGROUND AND SUMMARY

The present invention relates to the control of a motor vehicle. In particular, the invention relates to the control of a safety function of the motor vehicle.

A motor vehicle can be equipped by means of a safety device to protect a safety function from unauthorized use. The safety function may comprise, for example, releasing or locking an engine immobilizer, locking a door, a hatch or a window of the motor vehicle. The safety function can be controlled by means of a mobile device, which is in particular configured as a smartphone. A wireless connection can be set up between the mobile device and the motor vehicle. The mobile device and the motor vehicle can each use the connection to authenticate one another, and a predetermined safety function of the motor vehicle can be controlled by means of the mobile device. The safety function, for example opening a locking system, can be explicitly requested by a user of the mobile device or triggered automatically, for example when the mobile device is sufficiently close to the motor vehicle.

The safety function can be controlled, for example, by means of a technique known as Digital Car Key. A corresponding specification called Digital Key Release 3 is available in version 1.1.0 dated Jul. 20, 2022, for example.

To control the safety function of the motor vehicle, the wireless connection is needed. Initiating the connection can take much more energy than maintaining it. Therefore, once it has been initiated, activation at regular intervals of time is customary. To this end, the mobile device and the motor vehicle can negotiate an interval of time. The shorter the interval of time, the faster an arising volume of data can be transmitted via the connection. The longer the interval of time, the less energy may be needed for maintaining the connection. Normally, this conflict of aims is resolved by way of a compromise. For example, the interval of time may be approximately 30 ms.

So as not to restrict the use of the safety function of the motor vehicle to a mobile device, a dedicated hand-held unit that provides a corresponding functionality can also be used instead. To make the hand-held unit as small and lightweight as possible, an incorporated energy source may have small dimensions. It is therefore a matter of interest to operate the hand-held unit such that as little electrical energy as possible is employed.

An object on which the present invention is based is to provide an improved technique for controlling a safety function of a motor vehicle by means of a hand-held unit.

A method for controlling a safety function of a motor vehicle comprises steps of initiating a wireless connection between a hand-held unit and the motor vehicle; determining an expected volume of data that is supposed to be transmitted via the connection; determining an interval of time on the basis of the expected volume of data; and regularly activating the connection at the interval of time.

In contrast to a known technique in which the interval of time is determined for the connection only once, the dynamic adaptation of the interval of time allows the conflict of aims between rapid and energy-saving transmission to be resolved in an improved manner. If a significant volume of data is not expected, the interval of time can be chosen to be long, which means that energy for maintaining the connection can be saved. If, on the other hand, a significant volume of data is expected, the interval of time can be shortened, which means that a latency before data that have arrived are transmitted may be low. A speed of reaction of the motor vehicle to data that are to be transmitted may be high.

Preferably, the regular activation is carried out by the hand-held unit. An expenditure of energy by the hand-held unit to maintain the connection may therefore be reduced. Unlike the motor vehicle, the hand-held unit may have only little energy available. Optionally, the regular activation can also be carried out by the motor vehicle. The determination of the interval of time and the preceding determination of an expected volume of data are preferably likewise carried out by the hand-held unit.

The safety function aboard the motor vehicle may not be controllable without other tools. In particular, the safety function may require the use of a hand-held unit described herein. There is not normally provision for direct control of the safety function. Use of the safety function can be controlled manually or automatically by using the hand-held unit. In particular, the safety function may be designed to prevent unauthorized use of the motor vehicle. The safety function may comprise releasing or locking an engine immobilizer, opening or closing a door, a window or a hatch of the motor vehicle. Furthermore, the safety function can be used to control a child lock. Other safety functions can likewise be controlled in this way.

It is generally preferred for the safety function of the motor vehicle to be secured in the fashion of a digital vehicle key, in particular the Digital Car Key defined by the Car Connectivity Consortium. Other steps may also be needed to maintain a defined standard for protecting the safety function.

It is preferred for the interval of time to be coordinated between the hand-held unit and the motor vehicle. The coordination may comprise definition by the hand-held unit or negotiation between the hand-held unit and the motor vehicle. The negotiation may comprise one or more intervals of time being suggested by the hand-held unit and one of the intervals of time being confirmed by the motor vehicle. Data can be transmitted on a regular basis after every instance of an interval of time having elapsed. A transmitting device and/or a receiving device can be operated only at these times. If the connection cannot be activated multiple times in succession, it can be disconnected at one end. The control of the safety function is then initially no longer possible. To make the connection, it needs to be re-initiated.

It is particularly preferred for a probability of a volume of data being supposed to be transmitted to be determined; wherein the interval of time is shortened as the probability increases. As the probability decreases, the interval of time can be extended. To put it another way, the activation of the connection can take place more often the more probable it is that data will need to be transmitted. The probability of the volume of data can be determined in different ways here.

In one embodiment, the probability is determined on the basis of a movement of the hand-held unit with respect to the motor vehicle. If a movement takes place, the probability may be high. If no or only a small movement takes place, the probability may be low. The probability can be determined in one or more discrete stages or continuously in relation to the movement of the hand-held unit.

In another embodiment, the probability is determined on the basis of a movement of the motor vehicle. If the motor vehicle is moving, the probability of data to be transmitted may be low. If the motor vehicle is at a standstill, the probability may be increased. Here too, the probability can be determined in one or more discrete steps or continuously on the basis of the speed of movement.

It is possible to determine whether the hand-held unit is being moved by a running person. The probability can be determined on the strength of this determination. If the hand-held unit is being moved by a running person, a high probability can be assumed, otherwise a low probability. A speed of movement of the person can be taken into consideration for determining the level of the probability.

In yet another embodiment, the probability is determined on the strength of a distance between the hand-held unit and the motor vehicle. If the distance is short, the probability may be high. If the distance is long, the probability may be low.

The range can be determined in different ways. In one embodiment, a connection parameter of an interface that is used to handle the connection can be used. Such a parameter may comprise, for example, a signal strength (RSSI) or a signal-to-noise ratio (SNR). If the signal strength is low or the signal-to-noise ratio is high, a long distance can be assumed. Alternatively, the range can also be determined by means of a transmission method by said interface. The connection is preferably made between the hand-held unit and the motor vehicle by means of Bluetooth Low Energy (BLE). A present specification of BLE provides for the determination of a range between two communicating parties. The hand-held unit and the motor vehicle can also establish another connection, which is preferably provided by means of ultra-wideband technology (UWB). The other connection can be used to determine a range and a direction of the hand-held unit with respect to the motor vehicle in a more improved manner. The range determination can be controlled by means of data transmission via the BLE interface.

The probability can also be determined on the strength of a state of the motor vehicle. If the motor vehicle is switched off or parked, for example, a high probability can be assumed. If the motor vehicle is active or in motion, a low probability may be valid.

In addition to the probability, a capability of an energy store of the hand-held unit can be used to determine the interval of time. The more capable the energy store is, the shorter the interval of time can be chosen to be. The energy store may comprise in particular a storage battery or a battery. The capability of an electrochemical energy store such as this can be determined on the basis of an open-circuit voltage, an internal resistance, an ambient temperature or a model. The model can determine a remaining energy on the basis of energy originally available in the energy store and past energy draws. Additionally, it is possible to determine whether it has been observed that a voltage of the electrical energy store has fallen below a predetermined threshold value during the operation of a predetermined load. In this case, the capability of the energy store can be determined as being low.

A hand-held unit for controlling a safety function of a motor vehicle comprises a wireless interface for transmitting data and a processing device. The processing device is designed to initiate a connection to the motor vehicle via the interface; and to regularly activate the connection. An interval of time between activations is determined here on the strength of an expected volume of data that is supposed to be transmitted via the interface.

The hand-held unit and in particular its processing device may be designed to perform some or all of a method described herein. To this end, the processing device may be configured electronically and comprise, for example, an integrated circuit, a programmable logic chip or a programmable microcomputer. The method may be implemented in the form of a configuration or as a computer program product containing program code means for the processing device. The configuration or the computer program product may be stored on a computer-readable data carrier. Features or advantages of the method can be applied to the apparatus, or vice versa.

The hand-held unit may comprise an electrical energy store for providing a predetermined amount of energy. The energy store may be interpreted as a rechargeable or non-regenerative energy source. Preferably, the energy store is configured electrochemically and may comprise, for example, a storage battery or a battery. The battery may be in particular configured as a button cell.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system in accordance with at least one embodiment; and

FIG. 2 illustrates a flowchart of a method in accordance with at least one embodiment.

### DETAILED DESCRIPTION OF THE DRAWINGS

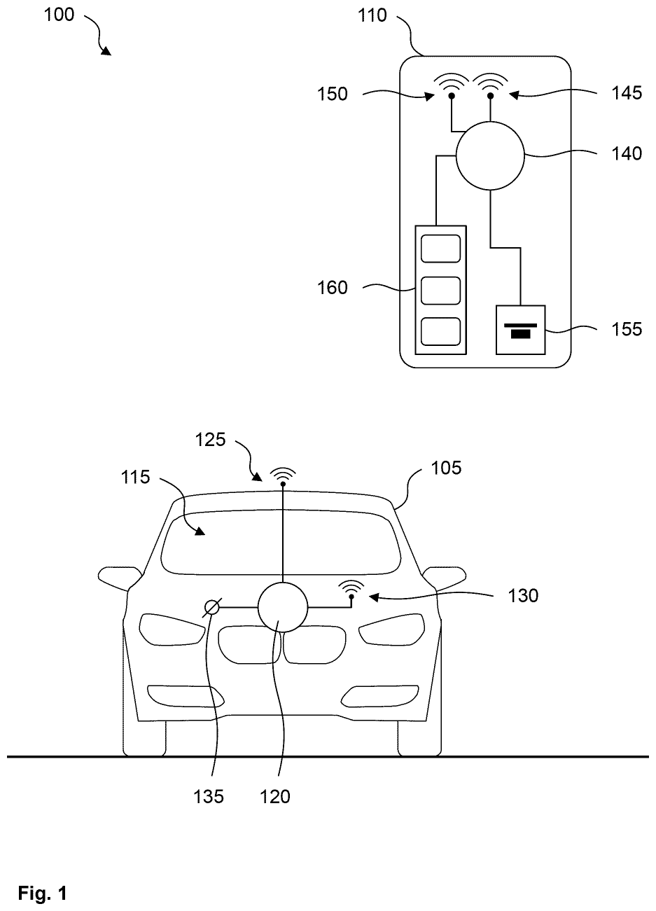

FIG. 1 shows a system 100 that comprises a motor vehicle 105 and a hand-held unit 110. Fitted aboard the motor vehicle 105 is a control apparatus 115 that is designed firstly to communicate with the hand-held unit 110 and secondly to control a safety function of the motor vehicle 105. The control apparatus 115 in the present case comprises a processing device 120, a first interface 125 and a second interface 130.

Both interfaces 125, 130 are configured wirelessly. The first interface 125 is designed to transmit data between the control apparatus 115 and the hand-held unit 110. Preferably, the first interface 125 operates according to a Bluetooth Low Energy standard.

The second interface 130 is likewise designed to communicate with the hand-held unit 110. Substantially no data are transported in this case, however, but rather a radiometric range determination is carried out. The second interface 130 preferably operates by means of ultra-wideband. There may be provision aboard the motor vehicle 105 for multiple antennas, which the second interface 130 comprises. Transmission of a series of impulses between the different antennas and the hand-held unit 110 allows relative ranges to be determined. The relative range can be taken as a basis for determining the direction that the hand-held unit 110 is in and the range that it is at.

There may be provision for a link 135 in order to communicate with another apparatus aboard the motor vehicle 105. The communication can be carried out in both directions. As such, the processing device 120 can control a safety function via the other device. Conversely, the other device can provide a state of the motor vehicle 105 to the control apparatus 115.

The hand-held unit 110 comprises a processing device 140, a first wireless interface 145, which corresponds to the first wireless interface 125 of the motor vehicle 105, and an optional second wireless interface 150, which corresponds to the second wireless interface 130 of the motor vehicle 105. Additionally, there is preferably provision for an energy source 155. An optional keypad 160 is designed to be operated by a user in order to request the performance of a predetermined safety function of the motor vehicle 105.

The energy source 155 is normally configured as an energy store that is designed to receive a predetermined amount of energy and to provide it to the hand-held unit 110. The energy store 155 may comprise in particular a storage battery or a battery. The energy store 155 may be permanently installed in the hand-held unit 110 or may be replaceably configured.

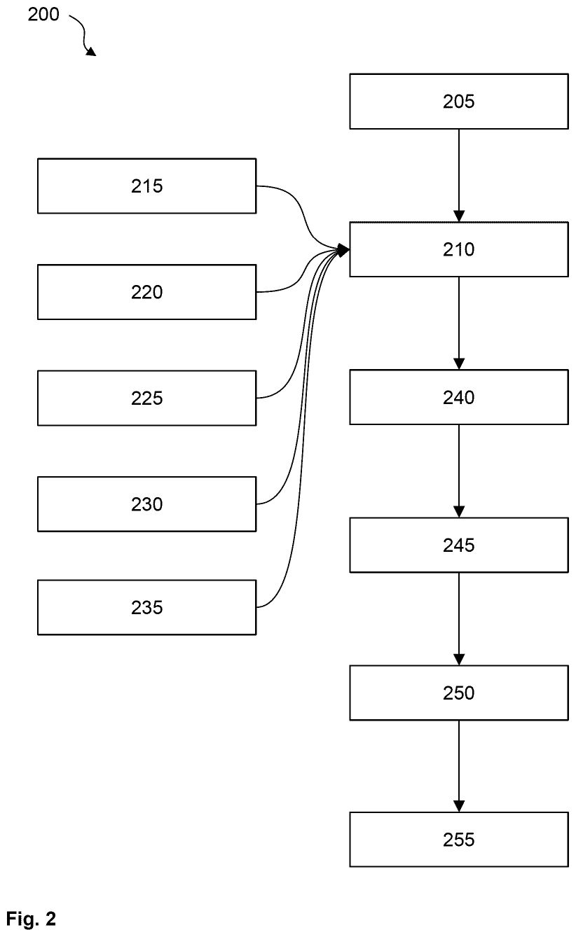

FIG. 2 shows a flowchart of a method 200 for controlling a safety function of a motor vehicle 105. In a step 205, a wireless connection can be initiated between the hand-held unit 110 and the motor vehicle 105. The connection is preferably made by means of the first interfaces 125, 145.

A step 210 can comprise determining a probability of a volume of data being supposed to be transmitted via the initiated connection. The probability can be determined in different ways. Optionally, various heuristics can be applied, which can be combined with one another in order to determine the probability.

By way of example, a step 215 can comprise determining a movement of the hand-held unit 110. The movement can be determined by means of an appropriate sensor on the hand-held unit 110, for example an inertial sensor.

A step 220 can comprise determining a movement of the motor vehicle 105. This can likewise be accomplished using a dedicated sensor. Alternatively, the movement of the motor vehicle 105 can be determined for example on the basis of a speed signal or a series of determined geographical positions of the motor vehicle 105.

A step 225 can comprise determining whether the hand-held unit 110 is carried by a running person. This can be accomplished by determining a pattern of movement of the hand-held unit 110 with respect to its environment. The pattern of movement is preferably determined by means of an acceleration sensor.

A step 230 can comprise determining a distance of the hand-held unit 110 from the motor vehicle 105. The distance can be determined on the basis of connection parameters of the connection via the first interface 125, 145 on the basis of one connection parameter or by means of a method of determination via the second interface 130, 150.

A step 235 can comprise determining a state of the motor vehicle 105. The state can indicate in particular whether the motor vehicle 105 is switched off, whether it is ready to go and/or whether it is in motion.

The probability of the imminent volume of data can be determined by checking one or more indicators of steps 215 to 235.

A step 240 can comprise determining a capability of the energy source 155 of the hand-held unit 110. The capability indicates how much energy can be drawn from the energy source 155. In particular, the capability may relate to a residual energy that can be drawn from the energy source 155.

A step 245 can comprise determining an interval of time for activating the connection between the first interfaces 125, 145. The interval of time is preferably determined by the hand-held unit 110 and on the basis of the probability determined in step 210 and/or the capability of the energy source 155 determined in step 240.

A step 250 can comprise coordinating the determined interval of time between the hand-held unit 110 and the motor vehicle 105. To this end, the interval of time can be transmitted from the hand-held unit 110 to the motor vehicle 105, or to the control apparatus 115 thereof. The interval of time can be provided as a binding specification, or an interval of time can be negotiated between the hand-held unit 110 and the motor vehicle 105, the hand-held unit 110 preferably attempting to place the interval of time as close as possible to the previously determined interval of time.

A step 255 can comprise regularly activating the connection that exists between the first interfaces 125, 145 on the basis of the negotiated interval of time. If the connection is active, available data can be transmitted. In one embodiment, every activation of the connection can result in a predetermined volume of data being transmitted. In another embodiment, the activation of the connection can be followed by as many data as are available for transmission being transmitted. Only then can the connection be periodically activated again. In phases in which the connection is not activated, the interfaces 125, 145 may be deactivated.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 system
105 motor vehicle
110 hand-held unit
115 control apparatus
120 processing device
125 first interface
130 second interface
135 link
140 processing device
145 first interface
150 second interface
155 energy source
160 keypad
200 method
205 initiate connection
210 determine probability of a volume of data
215 determine movement of the hand-held unit
220 determine movement of the motor vehicle
225 determine running person
230 determine distance of the hand-held unit from the motor vehicle
235 determine state of the motor vehicle
240 determine capability of the energy source
245 determine interval of time
250 coordinate interval of time
255 regularly activate connection

What is claimed is:

1. A method for controlling a safety function of a motor vehicle, the method comprising:
initiating a wireless connection between a hand-held unit and the motor vehicle;
determining an expected volume of data that is supposed to be transmitted via the connection;
determining an interval of time on the strength of the expected volume of data; and
regularly activating the connection at the interval of time.

2. The method of claim 1, wherein the regular activation is carried out by the hand-held unit.

3. The method of claim 1, wherein the safety function aboard the motor vehicle is controllable only by using a hand-held unit.

4. The method of claim 1, wherein the interval of time is coordinated between the hand-held unit and the motor vehicle.

5. The method of claim 1, further comprising:
determining a probability of a volume of data being supposed to be transmitted, wherein the interval of time is shortened as the probability increases.

6. The method of claim 5, wherein the probability is determined on the basis of a movement of the hand-held unit with respect to the motor vehicle.

7. The method of claim 5, wherein the probability is determined on the strength of a movement of the motor vehicle.

8. The method of claim 5, wherein it is determined whether the hand-held unit is being moved by a running person, and the probability is determined on the strength thereof.

9. The method of claim 5, wherein the probability is determined on the strength of a distance between the hand-held unit and the motor vehicle.

10. The method of claim 5, wherein the probability is determined on the strength of a state of the motor vehicle.

11. The method of claim 1, wherein the interval of time is determined on the strength of a capability of an energy store of the hand-held unit.

12. A hand-held unit for controlling a safety function of a motor vehicle, comprising:
a wireless interface for transmitting data; and
a processing device configured to:
initiate a connection to the motor vehicle via the interface, and
regularly activate the connection,
wherein an interval of time between activations is determined on the strength of an expected volume of data that is supposed to be transmitted via the interface.

13. The hand-held unit of claim 12, further comprising an electrical energy store for providing a predetermined amount of energy.
